(19) United States
(12) Patent Application Publication
(10) Pub. No.: US 2004/0121834 A1
(43) Pub. Date: Jun. 24, 2004

(54) Animated lottery bingo game

(76) Inventors: Budd O. Libby, Atlanta, GA (US); Daniel W. Bower, Atlanta, GA (US); Michael G. Fisk, Newport, RI (US)

Correspondence Address: Robert D. Katz, Cooper & Dunham LLP, 1185 Avenue of the Americas, New York, NY, 10036, US

(21) Appl. No.: 10/612,782

(22) Filed: Jul. 1, 2003

Related U.S. Application Data
(63) Continuation-in-part of application No. 10/218,155, filed on Aug. 12, 2002.
(63) Continuation-in-part of application No. 09/900,235, filed on Jul. 6, 2001, now Pat. No. 6,592,454.

(51) Int. Cl. A63F 13/00

(52) U.S. Cl. 463/19

(57) ABSTRACT

A lottery bingo system graphically portraying an animated bingo game is provided. The lottery system includes a bingo game generator which comprises an animation drawing subsystem. The animation drawing subsystem retrieves bingo call video segments corresponding to a sequence of drawn bingo numbers randomly drawn for a bingo game after dispensing of bingo tickets for the bingo game is ended, and compiles the bingo call video segments into a bingo game video.

### CROSS-REFERENCE TO RELATED APPLICATIONS

This application is a continuation-in-part, and claims the priority, of co-pending U.S. application Ser. No. 10/218,155, filed Aug. 12, 2002 and entitled “RANDOM ANIMATED LOTTERY SYSTEM”, and is a continuation-in-part, and claims the priority, of co-pending U.S. application Ser. No. 09/900,235, filed Jul. 6, 2001 and entitled “IMPROVED LOTTERY SYSTEM”.

### FIELD OF THE INVENTION

The present invention relates to computerized wagering or lottery systems, and more particularly to a lottery bingo system that graphically portrays the game in animation (or video).

### BACKGROUND OF THE INVENTION

Many states have used lottery or on-line games, such as number games (for example, Pick 3, Pick 4, Lotto, Mega Millions, etc.) and “instant winner” games, as an added source of revenue. These games have become quite popular and successful.

One type of state-run lottery game involves the use of numerous remote computer stations located in stores throughout the state which communicate with a central computer. A customer seeking to play the game may mark the numbers he wishes to enter as his choices on a computer scannable or readable entry form. The customer pays the entry fee, usually no more than a few dollars, and the store clerk feeds the entry form into a card reader controlled by a lottery computer station or terminal, which registers the numbers selected and an ID number in the central computer. Alternatively, the customer may choose several numbers, and the store clerk may enter the chosen numbers into the lottery computer by operating a keypad. In another variation, the customer may elect a Quick-Pick option that provides for random selection of the customer's numbers by a computer.

After wagering has been closed to new entries, a carefully monitored selection committee chooses the winning numbers. This may involve, for example, operating a machine loaded with balls having eligible numbers marked thereon to select at random the appropriate number of balls. This selection process often is broadcast on local television stations so that contestants can watch to see if their numbers have been selected.

Bingo is another popular form of gaming, in which participants engage as a pastime activity and/or in order to pursue their desire to wager. Each player in a bingo game receives a bingo card, which, in a traditional form of bingo, is a pre-printed card. The card contains a matrix of locations or spaces. As an example, a typical bingo card has a matrix of five rows and five columns of spaces, and each space has a corresponding bingo number (in a range of 1-75) printed in the space. As the bingo game is played, bingo numbers are drawn at random and “called” (i.e. announced to all of the players). If a called number matches any of the numbers on a player's card (i.e. the number is a “hit”), the player marks the space bearing that number. In order to win a bingo game, a player must achieve a predetermined winning pattern of hits (i.e. marked spaces) on his/her bingo card. The bingo cards may have one or more “free” spaces, which do not have a number and can form part of a winning pattern without being hit by any of the called bingo numbers.

Each game of bingo can have one or more winning patterns, as determined by the game's administrator (i.e. master of ceremonies or MC). The MC typically announces the selected pattern prior to commencement of the game. For example, in a typical game utilizing five-by-five bingo cards, the MC might announce that the winning pattern consists of hits in the five spaces in one row or column of the bingo card, or in the five spaces in one of the two main diagonals of a bingo card. In another game, the MC might announce that the winning pattern consists of hits in the four corner spaces of a bingo card.

In addition, a game may have progressive winning patterns. For example, once a player obtains hits on all of the corner spaces of his/her bingo card and collects a prize for that winning pattern, the game continues until a player obtains hits on the entire outside border of a bingo card, at which time a second prize is awarded. As another example of progressive winning patterns, the progressive winning patterns may consist of Letter X (FIG. 9A), Sputnik (FIG. 9B) and Blackout (FIG. 9C) patterns. Progressive winning patterns are typically announced in advance or as a game progresses, in order to maintain the interest of the players in the game.

A traditional bingo game is typically played in a single location, such as a bingo hall. In this traditional arrangement, players enter the game by purchasing or otherwise obtaining one or more bingo card which may be selected from a group of available cards, and then taking a seat in the bingo hall. Thereafter, the player monitors called numbers and marks his/her card(s) appropriately. It is a typical rule that when a player achieves a winning pattern of hits, the player must call out “bingo” in order to claim a prize. This rule encourages players to pay active attention to the game. When the player announces “bingo”, the player's card is compared to the called numbers to confirm that the player has won.

Bingo players who wish to increase their odds of winning may purchase multiple bingo cards (sometimes even half a dozen or more cards).

Many electronic and electromechanical devices have been proposed for assisting players with multiple bingo cards to keep track of their cards during a bingo game. See, for example, U.S. Pat. Nos. 4,651,995, 4,661,906 and 4,768,151, which are incorporated herein by reference. In addition, others have proposed computer-based systems for automating bingo games. See, for example, U.S. Pat. Nos. 4,909,516, 5,007,649, 5,043,887, 5,297,802, 5,351,970, 5,679,007, 5,687,971 5,904,619, 5,910,047, 5,921,865, 5,951,396, 6,024,641, 6,099,407 and 6,280,325. Lottery bingo games, like other state-run lottery games, have been adapted for broadcast to a broad audience.

Integrity of the winner selection process significantly increases the cost of running lottery bingo games and other lotteries. For example, each broadcasted drawing conventionally requires several individuals (e.g., a host or hostess, an auditor, a camera crew, and a set-up crew) to be present, and a television studio equipped with camera and lighting equipment.

In addition, states, and other entities running such lottery games have experienced some difficulties in increasing the number of interested day-to-day participants, and in maintaining the day-to-day interest of those who do participate on a regular basis.

As a result, a need exists for an automated lottery game which complies with government regulations without requiring extensive commitment of human and other resources, and which also enhances the intrinsic excitement of the game, in order to maintain and preferably increase the playing population.

### SUMMARY OF THE INVENTION

The present invention overcomes these and other disadvantages of prior games and provides a bingo game generator for a lottery bingo game, which comprises, according to one embodiment, an animation drawing subsystem. The animation drawing subsystem selects bingo call video segments corresponding to a sequence of bingo numbers randomly drawn for a bingo game, and compiles the bingo call video segments into a bingo game video. One or more pre-recorded video segments of an announcement of the bingo game result by a real person may be integrated in the bingo game video.

This disclosure also provides a lottery bingo system graphically portraying an animated bingo game, which comprises, in one embodiment, the bingo game generator and at least one lottery terminal configured to dispense bingo tickets to a player. The animation drawing subsystem retrieves bingo call video segments corresponding to a sequence of drawn bingo numbers randomly drawn for a bingo game, and compiles the bingo call video segments into a bingo game video.

The invention also provides a method of conducting an animated lottery bingo game comprising of comparing a sequence of drawn bingo numbers, which are randomly drawn for a bingo game, to bingo game numbers on a plurality of tickets to determine winning tickets and a winning sequence of bingo calls, retrieving matched video segments corresponding to the winning sequence of bingo calls, and compiling the retrieved matched video segments into a bingo game video.

The sequence of drawn bingo numbers may be randomly drawn and then compared to the bingo game numbers on the plural tickets sold. Alternatively, the comparison may be performed after each number is randomly drawn, with the drawing-followed-by-comparison process being iterated until one or more winners are determined.

### BRIEF DESCRIPTION OF THE DRAWINGS

The above and numerous other objectives, features and advantages that may be achieved by the subject matter of the present invention may be more readily understood from the following detailed description of the preferred embodiments by referring to the accompanying drawings wherein:

FIG. 1A is a block diagram of a lottery bingo system, according to one embodiment of the present invention;

FIG. 1B is a block diagram of a lottery bingo system, according to another embodiment of the present invention;

FIG. 1C is a block diagram of a lottery bingo system, according to a third embodiment of the present invention;

FIG. 2A is a block diagram of a bingo game generator, according to one embodiment of the present invention;

FIG. 2B is a block diagram of a bingo game generator, according to an exemplary embodiment of the present invention;

FIG. 3 is a block diagram of a remote station, according to an exemplary embodiment of the present invention;

FIG. 4 is a perspective view of a kiosk-type remote station;

FIG. 5 is an exemplary flow diagram showing operation of the remote station of FIG. 3 or FIG. 4;

FIG. 6 is an exemplary flow diagram showing data transfer operation of the bingo game generator of FIG. 2A or FIG. 2B to receive player selection data from a remote station; and

FIG. 7 is an exemplary flow diagram showing operation of the bingo game generator of FIG. 2A or FIG. 2B to generate lottery bingo results;

FIG. 8A a block diagram of a lottery bingo system, according to one embodiment of the present invention;

FIG. 8B is an exemplary flow diagram showing a method of conducting an animated lottery bingo game;

FIGS. 9A through 9C show schematic representations of Letter X, Sputnik and Blackout winning patterns, respectively; and

FIG. 10 shows a block diagram of an on-line bingo module, according to one embodiment of the present invention.

### DETAILED DESCRIPTION OF THE INVENTION

The present invention provides tools (in the form of systems, apparatuses and methodologies) for automating and animating lottery bingo games, which may be used to avoid the expenses of allocating facility, equipment and a staff of individuals to each bingo drawing. The lottery drawing may be automated and the results of the drawing graphically portrayed in animation and/or in video, as a virtual ball draw or another form of an animated bingo drawing. Optionally, announcement of the winning numbers (or other game parameters) by a real person in one or more pre-recorded video segments may be integrated with the animated game result. Accordingly, a computerized lottery or wagering system embodying the subject matter of this disclosure includes a bingo game generator which provides random selection of a sequence of drawn bingo numbers and compilation of an animated lottery game bingo video.

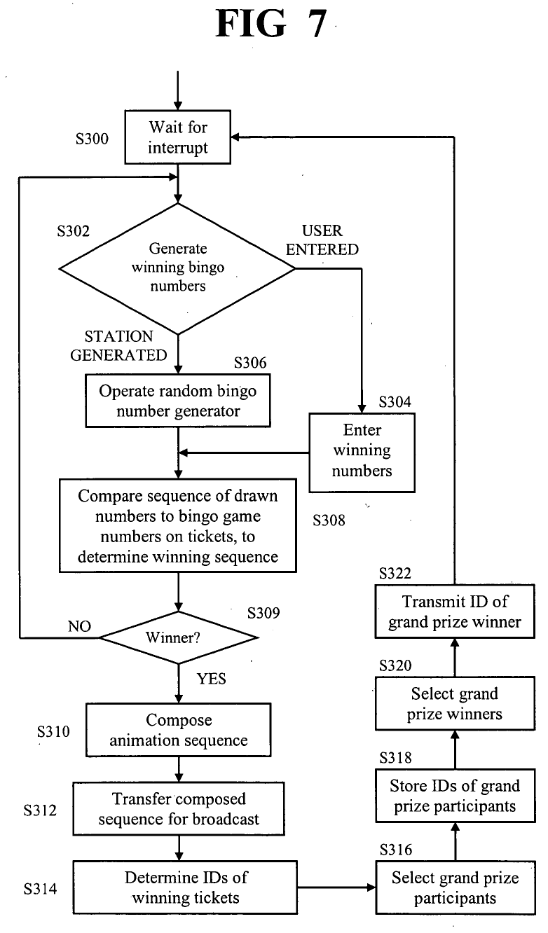

A lottery bingo system 80 graphically portraying an animated bingo game, according to one embodiment (FIG. 8A), includes a bingo game generator 81 and lottery terminals 83-1, . . . , 83-N, each of which is configured to dispense bingo tickets to a player.

The bingo game generator 81 includes an animation drawing subsystem 81a. The animation drawing subsystem 81a selects bingo call video segments corresponding to a sequence of bingo numbers randomly drawn for a bingo game, and compiles the bingo call video segments into a bingo game video. One or more pre-recorded video segments of an announcement of the bingo game result by a real person may be integrated in the bingo game video.

The lottery bingo system may optionally include a ticket validation module 85. Each bingo ticket is associated with a corresponding ticket identifier, and the ticket validation module stores game data for each ticket, including the ticket identifier and the bingo game numbers for the ticket. The ticket validation module compares the sequence of drawn bingo numbers to the bingo game numbers on a plurality of tickets to determine winning tickets and a winning sequence of bingo calls. The animation drawing subsystem retrieves matched video segments corresponding to the winning sequence of bingo calls which are determined by the ticket validation module and compiles the matched video segments into the bingo game video.

A method of conducting an animated lottery bingo game, according to one embodiment, will be explained with reference to FIGS. 8A and 8B. A sequence of drawn bingo numbers randomly drawn for a bingo game after dispensing of bingo tickets for the bingo game is ended at lottery terminals 83-1, . . . , 83-N, is compared by the ticket validation module 85 to bingo game numbers on a plurality of tickets to determine winning tickets and a winning sequence of bingo calls (step S91). Matched video segments corresponding to the winning sequence of bingo calls are retrieved by the animation drawing subsystem 81a (step S93). The retrieved matched video segments are compiled by the animation drawing subsystem 81a into a bingo game video (step S95).

A player typically is issued a ticket bearing bingo game numbers configured in a matrix as on a conventional bingo card. Each issued ticket may be assigned a unique multi-digit identifier which identifies the ticket with the matrix or matrices of bingo game numbers on the ticket. The identifiers of issued tickets are stored for selective retrieval. After wagering is closed, a sequence of drawn bingo numbers is randomly selected.

In order to create high churn (i.e. different ways to win) to stimulate interest, a lottery bingo game may have multiple winning patterns which are selected prior to the drawing, or progressive winning patterns which are announced in advance or as a game progresses.

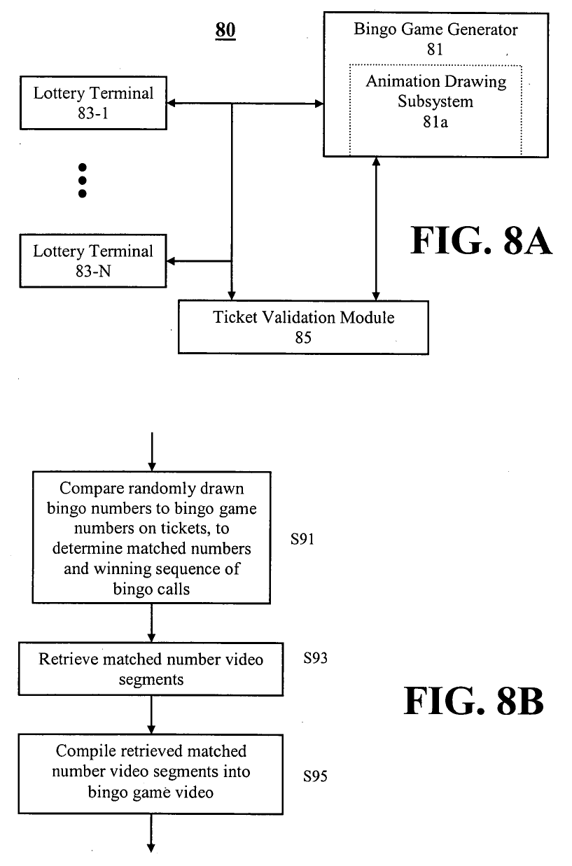

For example, the progressive winning patterns may include hits on all of the corner spaces of a bingo card for one prize, and hits on the entire outside border of the bingo card for another prize. As another example, the progressive winning patterns may consist of Letter X (FIG. 9A), Sputnik (FIG. 9B) and Blackout (FIG. 9C) patterns. The first player(s) to achieve a Letter X winning pattern receives a share of the 3^{rd} prize, the first player(s) to achieve a Sputnik winning pattern receives a share of the 2^{nd} prize, and the first player(s) to achieve a Blackout winning pattern receives a share of the first prize.

In order to maintain the interest of players who do not win the first, second or third prize, additional prizes may be awarded. For example, additional prizes may be awarded to players randomly picked from total player base, or players who were one, two or three calls away from having a winning pattern.

Optionally, a bingo ticket or card may include multiple matrices (also referred to as “faces” or “boards”). For example, a bingo card may have three faces. This allows for a number of different playing methods: (i) all three faces are played separately, with each face being for a different independent game; (ii) all three faces are played together in the same game; and (iii) all three faces are played together in the same game, but prizes are awarded to the winners by face.

For method (i), there are three independent draws and each draw is played against a different face on the card. The first draw is played against only the top face on all of the cards. The second draw is played against the middle face on all of the cards. The third draw is played against the bottom face on all cards. In each draw, players would have a chance to win one of the three prizes.

For method (ii), there is only one draw played against all three faces on the card. Players have three chances to win. This is similar to conventional bingo as players tend to play many cards at once.

For method (iii), there is only one draw played against all three faces on the card. However, prizes are awarded to the first player to match a pattern on each of the three different faces (i.e. the top face, the middle face and the bottom face).

If progressive winning patterns are added to the mix, there are nine chances to win, and the player can win up to three times on each face of the card. However, a limitation may be added so that although each card may win more than once, the player cannot win more than one prize on each game card and only the highest winning prize of each game card will be awarded to the player.

The bingo games may take place periodically at virtually any interval, e.g., one-game-per-half-hour, one-game-per-day, one-game-per-week, etc. If the games are broadcasted on public, cable or satellite television, the frequency of broadcasted games, of course, depends in part on program scheduling of the television station. The bingo game video may be published on a web site to which ticket holders connect to participate in a simulated bingo ball game.

A grand prize may optionally be provided. According to one embodiment, the identifiers of all winning bingo tickets are selectively retrieved. One of the retrieved identifiers may be randomly selected to determine a grand prize winner. Alternatively, the grand prize winner may be selected from the pool of all non-winners or all players of the lottery bingo game.

The bingo game generator, according to one embodiment, may be an on-line bingo module (OLBM) which may be integrated within an existing (for example, state-run) lottery system.

The OLBM may be a digital solution for playing, validating, and delivering lottery-draw entertainment content, which enables jurisdictions (such as states) to provide ticket holders with an interactive gaming experience over the Internet.

The OLBM can include random number generation, animation, media delivery, and game play and validation.

The OLBM can be adapted for the following exemplary lottery environments: (a) Single State/Single Game: a single state employs the OLBM to conduct one or more drawings on a daily or weekly basis; (b) Multiple States/Single Game: Multiple states individually employ the OLBM to conduct one or more separate drawings on a daily or weekly basis; and (c) Multiple States/Multiple Games: Multiple states will each play their own game ticket universe based on numbers drawn from a common source.

Within each of these scenarios, the procedures by which the game is conducted are fundamentally identical. For any given drawing, the on-line ticket sales systems for each participating state are configured to sell tickets from a specified “universe” (i.e. a large, enumerated collection of bingo cards). In scenario (a), the universe is the same for all states. In scenario (b), the universe may differ on a per state basis. At the close of ticket sales, each participating state's on-line ticket sales system reports to the OLBM an enumerated list of tickets sold within its jurisdiction. Once all states have reported, the OLBM electronically generates, in a fair, random manner, a complete series of seventy-five (75) bingo calls. The OLBM then uses these results to automatically determine the winning tickets (if any) in each state. In scenario (b), the tickets from all participating states are scored together as in any multi-jurisdictional drawing. In scenario (c), the tickets from each state are scored separately and independently. Finally, the OLBM publishes an enumerated list of winning tickets, along with the winning sequence of bingo calls (or the entire sequence of drawn bingo numbers), to the on-line ticket accounting systems in each participating state. Optionally, at the same time, the OLBM can publish the game information to a database server which can make the game information available to the Internet public via the World Wide Web.

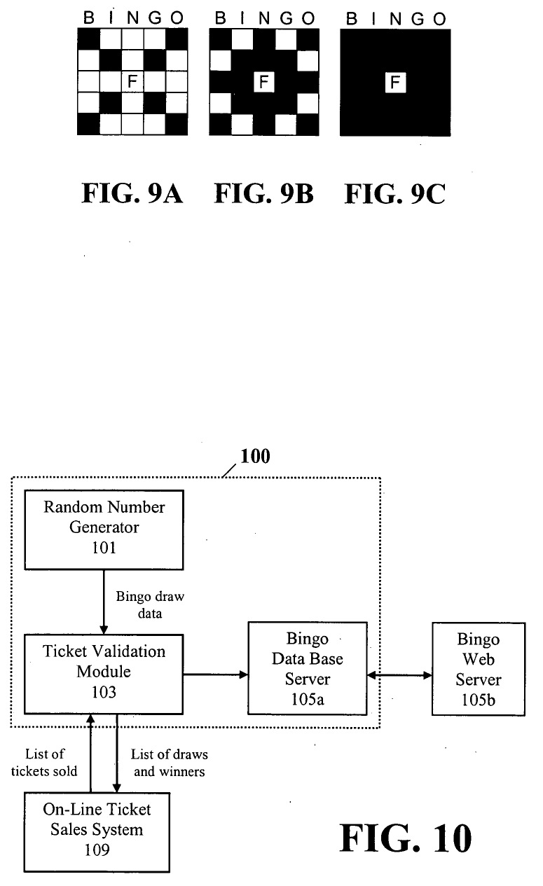

An OLBM 100, according to one embodiment (FIG. 10), may include a random number generator (RNG) 101 and a ticket validation module (TVM) 103. Additionally, for each jurisdiction which chooses to publish the draw information on the Internet, the OLBM can include an Internet publishing subsystem 105 which includes a bingo database server module 105a and at least one bingo web server 105b. A block diagram of the OLBM 100 interfacing with generic lottery facilities 109 is shown in FIG. 10.

In the case of scenario (a), the RNG 101 and the TVM 103 can be co-located at a secure state facility. In the case of scenarios (b) and (c), the RNG 101 and the TVM 103 modules can be distributed, with a single RNG located at a mutually agreeable secure facility and a TVM located at each participating state's secure facility.

The random number generator 101 can be based on the industry-standard Automatic Draw Machine currently supplied to several state lotteries. The RNG electronically generates a complete series of seventy-five (75) bingo calls in an unbiased and unpredictable fashion. Thus, the RNG generates winning numbers (or values) that are appropriate for the range of each game, the method of generating the winning numbers (or values) is unbiased and unpredictable, the RNG is secure and cannot be altered without discovery, and the process of transferring the winning numbers (or values) from the RNG to the validation process (usually on the central gaming system) is protected against error or malice.

The Ticket Validation Module 103, which receives as input enumerated lists of tickets sold in each jurisdiction, employs, in sequential order, a portion or all of the complete series of seventy-five (75) bingo calls generated by the RNG to determine which, if any, of the tickets are winning tickets. This validation process is completely automatic, and can be performed for very large sets of tickets with nearly instantaneous results. The TVM records detailed game data on a per-ticket basis, enabling states to offer associated electronic entertainment products (for example, bingo game video) in conjunction with their standard drawings. The game data allows a state, for instance, to publish a web site to which ticket holders can connect and play their tickets as if they were participating in a bingo hall game. Since all of the winners are indisputably determined at the time of the drawing, such simulated bingo hall activities would be for postdrawing entertainment purposes only (for example, after five calls, there are two tickets purchased for the current drawing that are only two calls away from being winners). It is not necessary for a ticket holder to visit such a web site, or actively play his/her tickets in any other manner in order to be eligible to win.

The Internet publishing subsystem 105 receives the draw information from the TVM 103, stores the draw information and provides it, on demand, over the Internet when requested by web browsers. The draw information is received from the TVM by the bingo data base server 105a component of the Internet publishing subsystem 105. The bingo data base server 105a can be housed in a different computer system from the bingo web server(s).

The number of bingo web servers may be selected according to the anticipated loads imposed by the enquiring web browsers. One of the benefits of employing a separate bingo web server to display data publicly from a secured database is that the data base server is not exposed to the Internet. For users to request a page, the web server must reside in a zone that is outside of the lottery firewall. From this position outside the firewall, the web server can publicly serve web pages without exposing information (for example, name, address, user account name and password, etc.) required to connect to the data base server.

In most common scenarios, the computer which contains the data base server resides behind the lottery firewall on a private network. When a user requests a page, the web server, not the Internet user, initiates contact with the database. On platforms such as Windows 2000 or Unix/Linux, this connection occurs at the operating system security level. Depending upon the system design, many additional authentication layers can exist between the Web server and the database server, including both firewall authentication and secured data base login. In most cases of high security, the web server can only connect to the data base through a valid operating system user account on the private network behind the firewall.

A user connecting to the web server from the Internet cannot see the data base server, nor does the user have the information or capability to log onto the database server directly. In essence, the data base server is transparent to the Internet user, and the data displayed is under the complete control of the system.

An on-line ticket sales system provides an enumerated list of tickets sold in its jurisdiction to the Ticket Validation Module 103. This interface can be implemented using a means of electronic transfer, via recordable media (disk, CD, or DVD) or manually.

The TVM 103 can provide an enumerated list of winning tickets, as well as the winning sequence of bingo calls (or the entire sequence of drawn bingo numbers) to the on-line ticket accounting system in each participating jurisdiction. If a jurisdiction publishes the draw information on the Internet, there is an additional interface from the TVM 103 to the Internet publishing subsystem 105. The interfaces can be implemented using a means of electronic transfer, via recordable media (disk, CD, or DVD) or manually.

An interface between the RNG 101 and the TVM 103 is mono-directional, or read-only, thereby ensuring that the TVM 103 can receive draw data from the RNG without having the capacity to write data in the opposite direction. This interface can be implemented using a means of electronic transfer, a mono-directional serial interface, via recordable media (disk, CD, or DVD) or another secure technique (such as via facsimile transmission).

The OLBM centralizes the generation of the series of bingo calls by utilizing a single RNG. Therefore, synchronization is not an issue as there is a single source that performs the random number generation for all drawings.

Each jurisdiction is responsible for maintaining the bingo data base server component of their Internet publishing subsystem, in order to ensure synchronicity of the results of a given draw as displayed on the Internet.

Due to the lack of external interfaces, the OLBM is inherently secure. As long as the interchange of information between the TVM and the online ticket sales and accounting systems for each state is safeguarded by normal security means (i.e., physical access to the machines is controlled, transfers of information occur over secure links such as facsimile machines and via CDs or DVDs, etc.), no opportunity exists for malicious programmers to access the OLBM.

The connection between the bingo data base server component and the web Server component of the Internet publishing subsystem is preferably configured so as to prevent external access during the brief period of time that the bingo data base server component is being updated with draw results by the TVM. While the draw results are being published by the data base server component, through the web server component, the connection between the data base server and the TVM is severed, in order to minimize the opportunities for malicious programmers to gain access to data that should be protected.

Upon completion of the ticket validation process, the TVM will hold all information necessary to uniquely identify any and all of the winning tickets within each state. The exact method by which each state is notified may depend on the on-line ticket accounting systems access policies and procedures of the involved organizations. In any event, the OLBM reliably informs jurisdictions of confirmed winners in a secure and timely manner through various forms of electronic transmission or recordable media.

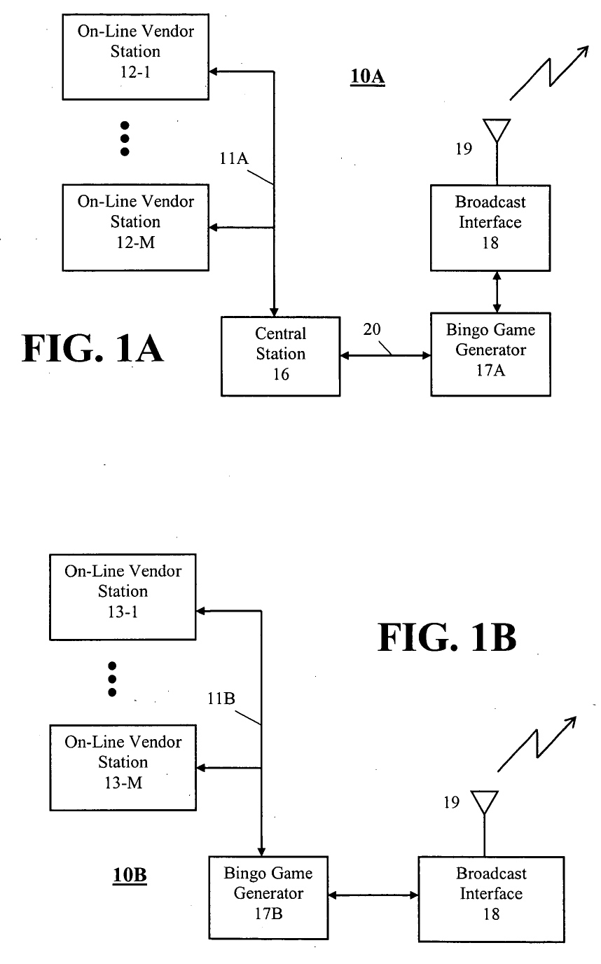

A block diagram of a lottery bingo system, according to another embodiment, is shown in FIG. 1A. Lottery bingo system 10A includes a plurality of remote on-line vendor stations 12 that are linked over a wide area network (WAN) 11A to a central station (or server) 16. A bingo game generator 17A is connected to the central station 16 over a computer or telecommunicative network 20 (such as the Internet). In the embodiment corresponding to FIG. 1A, the central station 16 acts as an interface between the bingo game generator 17A and the remote on-line vendor stations 12. As a result, the bingo game generator can connect to existing lottery bingo systems (for example, run by respective states) having a plurality of remote on-line vendor stations connected to a central station (or server). The central station serves as a communication interface for transferring the selected bingo game parameters from the remote vendor stations to the bingo game generator, and for transferring data regarding the randomly selected sequence of drawn bingo numbers from the bingo game generator to the remote vendor stations.

In another embodiment, the bingo game generator may communicate directly with the remote vendor stations. In an embodiment corresponding to FIG. 1B, bingo game generator 17B in lottery system 10B is connected directly to a plurality of remote vendor stations 13 via WAN 11B (or the Internet). The bingo game video may be transmitted via, for example, a closed circuit television line. In this embodiment (FIG. 1B), the system does not need to be connected to an existing lottery system.

Bingo boards are preferably obtained through Quick-Picks.

As an option in the embodiments exemplarily shown in FIGS. 1A and 1B, the remote vendor stations may be configured to provide on a graphic display a choice of bingo boards, bearing respective unique combinations of numbers, to a player for selection using one or more input devices such as, for example, a keyboard or key pad.

Typically, bingo board selection may be performed by an operator of the remote vendor station. Alternatively, if a kiosk type of remote station is used, the player can directly select the bingo board. In another embodiment, the player may be provided with an option of specifying the desired numbers on the bingo board which the player wishes to obtain. For example, the remote (vendor or kiosk-type) station may include a scanner for scanning a lottery entry form bearing player-selected bingo numbers.

In any event, the remote station transfers the selected bingo game parameters (including board identifier and/or bingo game numbers on the board) to the game generator either directly (FIG. 1B) or via the central station (FIG. 1A)

According to another embodiment, the bingo game generator may be integrated in a client-server lottery bingo system (FIG. 1C). Lottery bingo service is provided by a lottery bingo server 15, across WAN 11C (for example, the Internet), to a plurality of lottery bingo clients 14. Bingo game generator 17C is coupled to lottery bingo server 15. A client terminal may have a display, on which a choice of bingo boards are displayed for selection, and one or more input facilities, such as a keypad, interactive voice interface, etc., through which a player can specify the desired board. However, as mentioned above, bingo boards are preferably obtained through Quick-Picks.

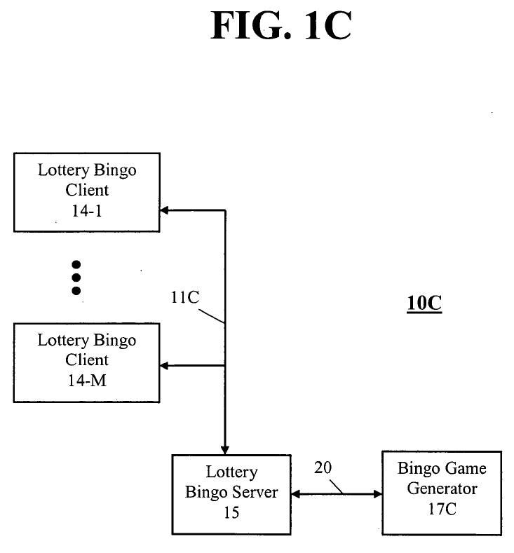

The bingo game generator preferably is a random, animated digital drawing system (RADDS). As shown in FIG. 2A, RADDS 21 includes a random bingo number generator 21A, an animated drawing subsystem (ADS) 21B and an optional bingo game generator controller 21C.

The random bingo number generator may be a hardware based number generator or a program based number generator, and either stand alone or integrated into the bingo game generator. Alternatively, an operator can randomly select the drawn bingo numbers and enter the numbers via a keyboard.

The random bingo number generator can select any number of picks from a set of bingo numbers. For example, with 75 numbers in the set, the random number generator can draw a sequence of anywhere from 1 to 75 numbers from the set.

The ADS 21B (FIG. 2A) includes a library of virtual images, animation elements and/or recorded video images.

In the embodiments corresponding to FIGS. 1A-1C, at a predefined time for each corresponding game, selection of game boards is ended for the game. The random number generator, automatically or when specified by an operator, randomly selects a bingo number. After the number is drawn, the drawn bingo number is forwarded to the bingo game generator. The bingo game generator performs a ticket validation process to compare the sequence of drawn bingo numbers to the stored bingo game parameters in order to determine if there is a winning ticket(s) and the portion of the bingo calls which resulted in the corresponding match of the winning pattern (referred to herein as “winning sequence”). Bingo numbers are drawn, forwarded, and compared until a winner(s) is determined

Next, selected virtual images and animation elements corresponding to the winning sequence of bingo calls are retrieved and composed into animation sequences.

For example, the animated lottery game may be fashioned as an animated, virtual ball draw. As mentioned above, bingo drawings are often conducted by using a machine loaded with numbered plastic balls or other numbered pieces. However, the expense of undertaking such conventional drawings is great since a collection of audio-video equipment and a staff of personnel must be allocated for each drawing. The virtual draw does not require such expense and resource allocation, after the initial setup, since it can be automated. Further, automation of the drawings also facilitates auditing and archiving, since human input is removed from the automated process.

When the sequence of drawn bingo game numbers is randomly selected, animation segments corresponding to the numbers in the sequence are retrieved from the library of the ADS 21B, and the animation segments are composed into a video sequence. Alternatively, animation segments corresponding to the winning sequence of bingo calls are retrieved from the library of the ADS 21B, and the animation segments are composed into a bingo game video.

Thus, for example, if a winning sequence of bingo calls includes 29, 3, 17, . . . , an animation segment corresponding to virtual draw of a number twenty-nine ball, an animation segment corresponding to virtual draw of a number three ball, and an animation segment corresponding to virtual draw of a number seventeen ball are retrieved from the library and appended one to another and to the animation segments corresponding to virtual draw of other numbers in the sequence, to provide a virtual draw of the twenty-nine, three and seventeen balls within a sequence. In order to provide some variety, the library may store a number of variations of the virtual drawing of each numbered ball. For example, color and design may vary. When the number twenty-nine appears in the sequence of drawn bingo numbers, one of the plural animation segments corresponding to virtual drawing of the number twenty-nine ball is selected and retrieved from the library.

In addition, the ADS 21B may optionally include a real people announcement component, and the animated lottery game video thereby includes announcement of the sequence of drawn bingo numbers by a real person in one or more pre-recorded video segments. For example, for each drawn bingo number, announcement by a real lottery spokesperson of selection of the number for the sequence of drawn bingo numbers may be pre-recorded in a video segment, and the video segment is stored in the library. Further, the video segment may be associated with the animation segment (also stored in the library) corresponding to the virtual draw of the corresponding numbered ball, and when the animation segment is retrieved, the associated video segment of the real person announcement is also retrieved. The virtual ball draw and the real person announcement may be displayed simultaneously (and synchronously), for example, in a split screen.

The terms “video segment” and “animation segment” are used broadly herein (including in the appended claims) to cover the possibility of including audio tracks with the video or animation. According to one embodiment, an audio track may be integrated with a video segment. In another embodiment, when video segments are selected and compiled, the selection and compilation process also includes independently selecting and compiling audio tracks. A variety in the available audio tracks, like variations in video and animation, contributes to the intrinsic excitement of the game.

In embodiments in which animated game events are broadcasted (for example, corresponding to FIGS. 1A and 1B), an animation sequence corresponding to the winning sequence of bingo calls may be retrieved, formatted for broadcast, and broadcasted using standard television transmission techniques via, for example, RF transmission, microwave transmission, fiber optic cabling or closed circuit television lines, so that the players can watch the game on a television and root for their selections. Alternatively, the animation sequence corresponding to the winning sequence of bingo calls may be retrieved, formatted for broadcast, and broadcasted, on the Internet. In addition, the system determines which players are eligible for a grand prize pool, and after the broadcast of the game, announces the grand prize winner.

To broadcast the animation sequence of the game, the bingo game generator may be connected to a broadcast interface 18 which formats the animation sequence data for broadcast via antenna 19 (FIGS. 1A and 1B). In this configuration, the broadcast interface is configured for RF transmission of television signals. The video is transferred in accordance with known RF transmission methods. Alternatively, the broadcast interface can be configured to format the video data for microwave transmission to satellites and reception by the public on conventional satellite dishes. In another alternative configuration, the broadcast interface can be configured to transmit the video along fiber optic cabling or on closed circuit television lines. According to another embodiment, the broadcast and/or communication with the vendor stations may be through either a wired or wireless connection to the Internet. Similarly, in the embodiment corresponding to FIG. 1C, the video may be made accessible on demand to the clients through the WAN.

A bingo game generator according to one configuration will now be described with reference to FIG. 2B. Bingo game generator 22 preferably includes a microprocessor-based bingo game generator controller 23 and one or more storage devices 24. A random bingo number generator 25 (similarly to the random bingo number generator 21A in FIG. 2A) optionally may be included in the bingo game generator 22, for randomly selecting the drawn bingo numbers.

The bingo game generator controller 23, coupled with assorted software components, control operations and functionalities of the bingo game generator. The controller 23 may be a suitably programmed microprocessor or microcontroller, an application specific integrated circuit (ASIC), a programmable logic device, or (as one skilled in the art should understand and appreciate) a collection of discrete components suitably laid out and connected on a printed circuit board.

The software components may include hardware management functions, such as assorted device drivers, including a wireless communication driver if a wireless interface is provided.

In addition, the software components may include a user interface. The user interface provides means for managing and configuring the library of virtual images and animation elements offline. Further, a user, through the user interface, can customize the desired graphic elements (for example, logos, posted lottery results, etc.) to be displayed, as well as configure the animated drawing system.

The user can specify, through the user interface, that the animated bingo result is to be a compilation of video segments and animation sequence(s) and specify the timing of the video segments and animation sequences. For example, the animated lottery results may be announced and combined (such as spliced) with a winners' gallery video. Further, the user can specify that the animated bingo game video should be integrated with announcement of the lottery bingo result by a real person in one or more pre-recorded video segments. As another example, in the case of a state-run lottery, the animated lottery game may be preceded by video segments which present the benefits obtained by state residents from lottery revenue (such as public education, state and local governments, law enforcement, etc.).

More advanced tools for customizing the look and feel of the animated lottery result may also be provided through the user interface. For example, the user interface may provide means (in the form of well-known graphical interface elements, such as tables, menus, buttons, drop-down lists, tabs, etc.) for specifying and/or selecting the parameters for compositing (or blending) the animation elements and virtual images. The user interface may also be used to configure special effects to be displayed. In addition, the user interface may be used to reserve a window within the display (for example, a virtual picture-in-picture) for showing other information. Thus, for example, the reserved window may show sports scores, stock market indices, etc.

Any of many well-known animation and compositing techniques (not discussed in detail herein, in the interest of clarity) may be provided and configured through the user interface, such that one or more virtual overlays of graphical (or other visual) information may be presented.

In addition, the animated lottery bingo results may include one or more voice overlays and/or audio tracks. The user interface may also provide means for synchronizing the voice overlays and audio tracks with the animation sequences and video segments.

The storage devices may include one or a combination of buffers, registers and memories [for example, read-only memory (ROM), programmable ROM (PROM), erasable PROM (EPROM), electrically erasable PROM (EEPROM), non-volatile random access memory (NOVRAM), etc.]. Other storage devices may include, for example, floppy disk drive, CD (or DVD) drive, hard disk, and other mass storage devices. The storage devices may include a storage area network (SAN).

The storage devices store code and data for the bingo game generator controller 23. For example, the storage devices may store programs, such as system and application programs, and provide sufficient storage capacity also to store numerous animation sequences associated with the particular game.

The storage devices may also store an archive of lottery game results. Such archive may provide an audit trail which facilitates audits of the system. In addition to the storage devices, analysis tools may be provided. The combination of the archive and analysis tools provides means for obtaining statistics and historical data.

The bingo game generator 22 may operate through one or more wired or wireless networks and include a network communication interface 28 that is configured for bidirectional communications with the remote on-line vendor stations (and/or with a central station or lottery server). In a networked system, the network communication interface 28 may include interfaces for communicating electronically with one or more other terminals or data sources (for example, vendor stations or a lottery server) through telecommunication or computer networks. Such networks may include the Internet, an intranet, an extranet, a LAN (local area network), a WAN (wide area network), a wireless network, a satellite network and other networks. For example, video sequences may be downloaded through the networks from a remote source (for example, a storage area network or a server). As another example, the software components may be received through the network communication interface, and each software component may comprise one or more segments.

In one embodiment (FIG. 2B), the network communication interface 28 includes a microprocessor-based communication controller, memory for storing data (for example, data to be transferred via the network, and valid data received from the network for subsequent transfer to the game generator controller) and programs (such as system and application programs), one or more modems and corresponding serial interfaces (the controller is coupled to the modems via the serial interfaces). Depending upon the communication requirements of the system (i.e., the communication traffic), there may be a number of modems and corresponding serial interfaces to accommodate a large number of remote player stations. The serial interfaces provide a serial data buffer to the communication controller.

In any event, the network communication interface 28 includes the appropriate conventional units for interfacing with the networks, including, for example, Ethernet card, modem, wireless modem, etc. Interfaces for such communication are well known. Therefore, the interfaces are not described in detail here.

Animation may be accomplished in accordance with a number of computer generated animation techniques, such as the methods disclosed in U.S. Pat. Nos. 4,951,039, 4,873,585 and 4,752,836, whose disclosures are incorporated herein by reference.

After the sequence of drawn bingo numbers is randomly selected, by the random bingo number generator or by an operator, and the winning sequence of bingo calls is determined, the bingo game generator controller 23 retrieves a predefined video sequence of the bingo game from the storage devices 24 and prepares the video sequence for broadcast. The video sequence preferably comprises a plurality of stored segments. Thus, in the preferred embodiment, the bingo game generator controller randomly selects for each stage of the video sequence one of the segments appropriate for that stage, and composes the selected segments for each stage into a seamless video sequence.

The video data is preferably in digital form and may be formatted by, for example, a graphic/animation buffer 29 for transfer to the broadcast interface and/or to network communication interface 28.

In a preferred embodiment, segments are rendered directly to a digital compressed format such as MPEG 2. This allows the stored video image to be a very high quality. At the time of broadcast, the segments are concatenated together and fed to the broadcast interface which typically transmits a NTSC compatible analog signal. MPEG 2 is the same format used by satellite transmitters such as Direct TV. When the broadcast is via satellite, the MPEG 2 files may be transmitted directly without having to be converted (i.e. decompressed). Also, the data may be transmitted in serial digital format.

Generally, each remote on-line vendor station is configured for operation by an operator (for example, store personnel), or for operation directly by the player. For example, the player enters the bingo game parameters (such as by selecting one of a number of available bingo game cards or by specifying the desired bingo game numbers), and pays for the game at the site of the remote station. The entered bingo game parameters are also referred herein as “player selection data”. It should be understood that the terms “player selection” and “player selection data” are used broadly herein to cover the various possible methods of selection of bingo game numbers, including Quick-Pick, player selection of one of a number of available game boards, specification of the bingo game numbers by the player, etc.

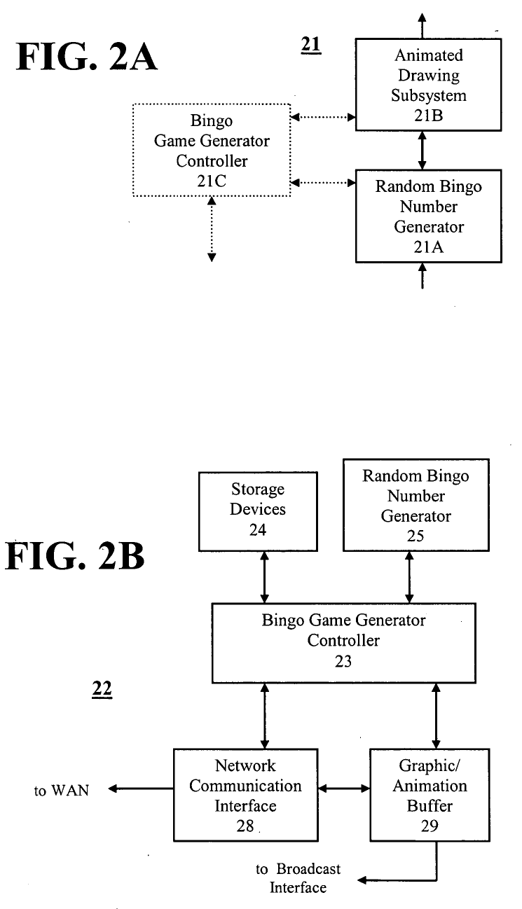

FIG. 3 shows a block diagram of a remote on-line vendor station, according to an exemplary embodiment. Remote on-line vendor station 30 includes a controller-processor 31 connected to one or more storage devices 32 (such as RAM, ROM, other memory devices, and/or mass storage devices) for storing system and application programs. An input/output interface 33 couples the station controller 31 to assorted input/output devices, including a printer 34, a display 35 (such as a LCD display, a monitor and the like, to provide visual messages or prompts to the operator or player), a card reader 36, a payment card reader 37, or other input/output devices 38, such as keyboard, keypad, mouse, track ball, stylus, microphone, touchpad, touchscreen, speaker, etc., plus the appropriate device drivers.

As another example, a voice interface may be provided along with a microphone. Spoken words are picked up through the microphone and converted by applying speech recognition (software and/or hardware) technology. For example, a user, with visual prompt provided on the display, such as in the form of text and/or graphics, may give an oral command, which is then converted through speech recognition and triggers operation. Text-to-speech technology also may be integrated. Thus, a voice prompt also (or alternatively) may be provided.

Network communication interface 39 is connected to a wide area network and to the station controller 31 to facilitate data communication between the remote on-line vendor stations and the game generator, directly or via a central station.

The remote on-line vendor station may be configured for installation in, for example, a retail store and operated by personnel within the store. The player (or customer) selects, for example, the bingo game numbers and the operator can either enter the bingo game numbers via an input device such as a keyboard, a card reader or a voice interface, or elect the Quick-pick option for random selection of the numbers by a computer. Player selection data may be stored along with corresponding player identification data. The player identification data may be the player's social security number or other indicia which associate the player with the player selection data.

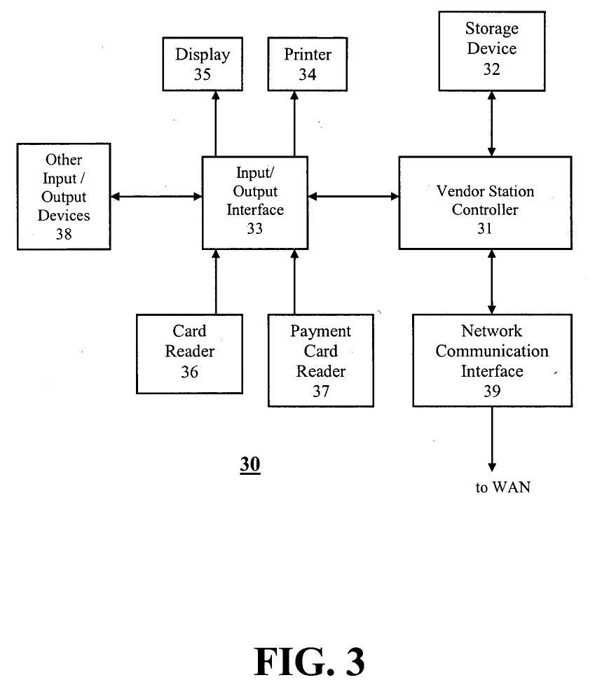

In an alternative configuration, a kiosk-type remote on-line station 40 is shown in FIG. 4. The internal components for the kiosk 40 are shown in FIG. 3. The kiosk 40 includes a stand alone housing 42 that may be located in public locations, such as shopping malls, and players can enter player selection data via an input device, such as a keyboard, a card reader, etc. In this embodiment, payment for the entry into the lottery may be made by cash or by a payment card medium, such as credit card, a debit card or the like, which is inserted into card reader 78. A ticket or receipt of the transaction is provided by the printer 34. It should be understood that the kiosk-type station may have many of the user interface features described above.

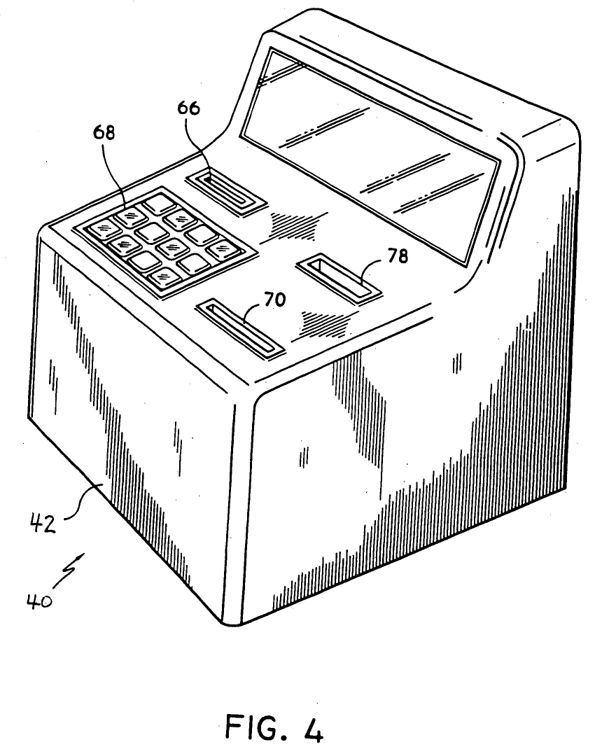

FIG. 5 is an exemplary flow diagram of the operation of the remote on-line vendor station. Initially, the remote station is maintained in an idle state in step S100 wherein the display 35 can be continuously updated to show, for example, statistical data and to provide instructions regarding how to enter player selection data. Once an interrupt is received by the station controller 31, the controller initiates a data entry routine. If the remote station is a kiosk (step S102, “KIOSK”), the player is prompted to insert a payment card into card reader 78 (step S104). The station controller 31 then verifies that the card is valid by, for example, automatically contacting known credit agencies via the network communication interface 39 and receiving a code indicating whether the card is valid or not (step S106). If the card is invalid (step S106, “NO”), then the player is notified (step S108) that the transaction cannot be completed and the station returns to the idle state (step S100). If the card is valid (step S106, “YES”), the player is instructed to enter the player selection data (step S110). If the remote station is operated by an operator, the station prompts the operator to enter the player selection data which as noted above can be entered by a keyboard, a card reader, or another input device (step S110).

In any event, when the player selection data is entered, the station controller 31 stores the data in the storage devices 32, typically in RAM (step S112). Once the player selection data is completely entered (step S114, “NO”), the controller 31 instructs the operator to enter identification data which is associated with the player selection data for verification purposes in the event the player (a) is a bingo game winner or (b) qualifies for and wins the grand prize (step S116). An example of player identification (ID) data is a social security number.

In addition to requesting player ID data, the station controller 31 retrieves the time of day and date (i.e., time tag data) from a clock (not shown) within the remote station (step S116) and associates the player selection data with a particular time and day for determining if the player has a winning ticket (step S118). The ID data and the time tag data are stored along with the corresponding player selection data (step S120).

Once the player selection data, the player ID data and the time tag data are stored, the data is sent to the bingo game generator, directly or through a central station, via the network communication interface 39 (step S122). If the remote on-line vendor stations are connected directly to the bingo game generator then data is sent to the bingo game generator over the WAN. After the data is transmitted to the bingo game generator, the remote station waits for the bingo game generator to reply that it received the player selection and associated ID and time tag data (step S124). If the reply is that the data received was invalid (step S126, “NO”), the operator or player is notified that a transmission error occurred (step S128) and the station returns to the idle state (step S100). If the reply is that the data transfer is complete (step S126, “YES”), the player selection data and associated ID and time tag data are printed on the printer 34 to provide the player with a receipt of the transaction which can be used by the player to claim any winnings (step S130). After the receipt is printed, the station returns to the idle state (step S100).

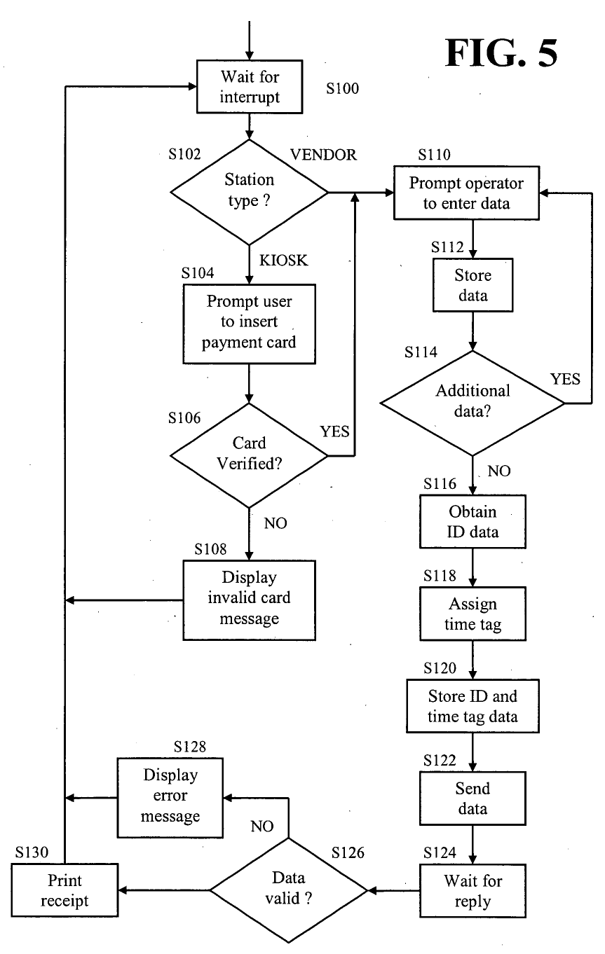

FIG. 6 is an exemplary flow diagram of the transfer of data to the bingo game generator. The bingo game generator is initially in an idle state (step S200) and upon receiving an interrupt performs the desired routine. The interrupt may be a request from the remote station to send player selection data to the bingo game generator. When the remote station requests data, the bingo game generator provides a reply indicating that the bingo game generator is or is not ready to receive the data (step S202). When the bingo game generator is ready to receive data, the remote station sends the data to the bingo game generator which stores the data in the network communication interface memory (step S204). The network communication interface controller determines if the data transaction is complete (step S206). If the data transaction is incomplete (step S206, “NO”), the bingo game generator replies to the remote station that the transaction is incomplete (step S208) and returns to the idle state (step S200). If the data transaction is complete (step S206, “YES”), the bingo game generator replies that the transaction is complete (step S210) and transfers the player selection, the ID and the time tag data to the storage device 24 (step S212).

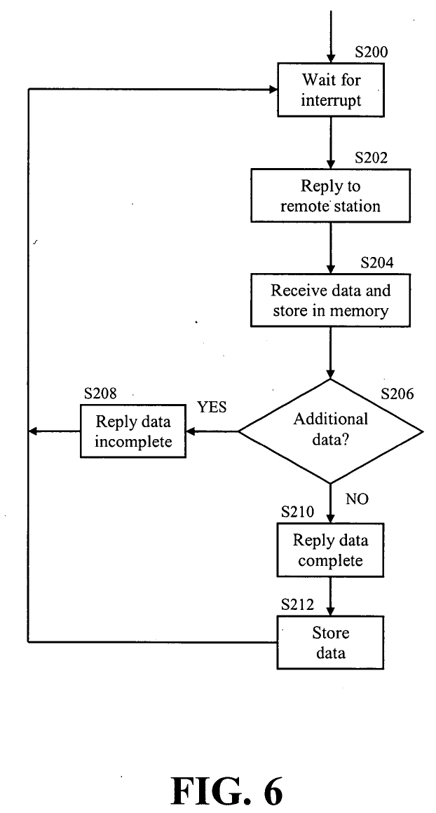

FIG. 7 is an exemplary flow diagram of the operation of the bingo game generator for generating the lottery bingo results. Initially, the bingo game generator is in an idle state (step S300) and upon receiving an interrupt (for example, an operator-selected start command), the generator determines a sequence of drawn bingo numbers for a particular game and winner(s).

The drawn bingo numbers can be randomly chosen and entered into the generator by an operator using a keyboard or another input device (step S302, “USER ENTERED”, and step S304), or generated by random bingo number generator 25 (step S302, “STATION GENERATED”, and step S306).

The bingo numbers are entered one at a time or each drawn bingo number is obtained by the bingo game generator, the controller 23 compares the resulting sequence of (presently and previously) drawn bingo numbers to the bingo game numbers on purchased tickets to determine a winning sequence of bingo calls (step S308).

After the winning sequence of bingo calls is determined (step S309), the controller 23 composes a video sequence having an outcome that corresponds to the winning sequence (step S310). As discussed above, the video sequence is preferably a seamless composition of animation elements (and/or video segments) randomly selected for corresponding stages of the video sequence.

The composed video sequence is then transferred (step S312) via the network communication interface or the broadcast interface for broadcast, as described above. Before broadcasting the video sequence, the bingo game generator determines the identity of winning tickets (step S314). The identity of winning tickets may be determined before, concurrently with or immediately after the winning sequence is determined.

The bingo game generator controller 23 then optionally determines which players qualify for the grand prize (step S316). For example, all players of the game may qualify for the grand prize. The identities of the grand prize participants may be stored in, for example, a grand prize data table (step S318) and the winner of the grand prize may be randomly selected through operation of the random bingo number generator 25 (step S320). After the winner of the grand prize is selected, the name of the winner(s) is broadcasted (step S322).

Although the subject matter of the present disclosure is explained exemplarily above using a virtual ball draw, it should be understood that the tools described herein may be adapted for other variations of an animated bingo drawings, with randomly selected results, which reduce drawing costs while increasing entertainment value to lottery players, as well.

Various modifications can be made to the embodiments of the present disclosure herein without departing from the spirit and scope thereof. For example, various types of network resources and protocols may be used for the wide area network and various central and remote station configurations may be employed. Likewise, various animation techniques may be used to animate the game through which the lottery winner is graphically portrayed, and various types of games may be adapted to animate the lottery game. Further, the animated lottery bingo game may be combined with a video announcement of the bingo game winner or sequence of drawn bingo number by a real person.

In addition, although the description of exemplary embodiments above refers to selection of numbers (as game parameters) and random selection of a sequence of drawn bingo numbers, it should be apparent that the embodiments may be readily adapted for selection of other types of game parameters, such as character, letters, symbols, etc.

Furthermore, the terms “ticket”, “bingo ticket”, “bingo card”, “bingo board” are used broadly and interchangeably herein to denote any of the various possible media in which the bingo game numbers may be embodied. Thus, the bingo ticket, card or board may be akin to conventional bingo cards or boards, pre-printed instant lottery tickets, Lotto tickets printed on a printer after the desired numbers are selected, an electronic ticket which is associated with a corresponding ticket identifier and may or may not be printed at all, etc.

The above description should not be construed as limiting the disclosure, but merely as disclosing preferred. embodiments thereof. Those skilled in the art can envision other modifications within the scope and spirit of the disclosure as defined by the claims appended hereto.

For example, additional variations may be apparent to one of ordinary skill in the art from reading U.S. applications Ser. Nos. 09/900,235 and 10/218,155, filed Jul. 6, 2001 and Aug. 12, 2002, respectively, which are incorporated herein by reference.

What is claimed is:

1. A lottery bingo system graphically portraying an animated bingo game, comprising:
at least one lottery terminal configured to dispense bingo tickets to a player; and
a bingo game generator including an animation drawing subsystem,
wherein the animation drawing subsystem retrieves bingo call video segments corresponding to a sequence of drawn bingo numbers randomly drawn for a bingo game after dispensing of bingo tickets for the bingo game is ended at the at least one lottery terminal, and compiles the bingo call video segments into a bingo game video.

2. The lottery bingo system of claim 1, wherein the bingo game video further includes one or more pre-recorded video segments of an announcement of the bingo game result by a real person.

3. The lottery bingo system of claim 1, further comprising a ticket validation module, wherein the drawn bingo numbers are randomly drawn iteratively, and the ticket validation module compares the sequence of drawn bingo numbers to bingo game numbers on a specified ticket to determine matched numbers on the ticket.

4. The lottery bingo system of claim 3, wherein the ticket validation module compares the iterative sequence of drawn bingo numbers to the bingo game numbers on a plurality of tickets to determine winning tickets and a winning sequence of bingo calls.

5. The lottery bingo system of claim 4, wherein the animation drawing subsystem retrieves matched video segments corresponding to the winning sequence of bingo calls which are determined by the ticket validation module and compiles the matched video segments into the bingo game video.

6. The lottery bingo system of claim 3, wherein each bingo ticket is associated with a corresponding ticket identifier, and the ticket validation module stores game data for each ticket, including the ticket identifier and the bingo game numbers for the ticket.

7. The lottery bingo system of claim 1, wherein the bingo game video is published on a web site to which ticket holders connect to participate in a simulated bingo ball game.

8. A method of conducting an animated lottery bingo game comprising:
comparing a sequence of drawn bingo numbers randomly drawn for a bingo game after dispensing of bingo tickets for the bingo game is ended, to bingo game numbers on a plurality of tickets to determine winning tickets and a winning sequence of bingo calls;
retrieving matched video segments corresponding to the winning sequence of bingo calls; and
compiling the retrieved matched video segments into a bingo game video.

9. The method of claim 8, further comprising integrating in the bingo game video one or more pre-recorded video segments of an announcement of the bingo game result by a real person.

10. The method of claim 8, further comprising publishing the bingo game video on a web site to which ticket holders connect to participate in a simulated bingo ball game.

11. A system, comprising:
a processor; and
a program storage device readable by the system, tangibly embodying a program of instructions executable by the processor to perform the method claimed in claim 8.

12. A program storage device readable by a machine, tangibly embodying a program of instructions executable by the machine to perform the method claimed in claim 8.

13. A computer data signal transmitted in one or more segments in a transmission medium which embodies instructions executable by a computer to perform the method claimed in claim 8.

14. A bingo game generator for a lottery bingo game, comprising an animation drawing subsystem, wherein the animation drawing subsystem selects bingo call video segments corresponding to a sequence of bingo numbers randomly drawn for a bingo game, and compiles into a bingo game video the bingo call video segments along with one or more pre-recorded video segments of an announcement of the bingo game result by a real person.

15. The bingo game generator of claim 14, wherein the bingo game video is published dn a web site to which ticket holders connect to participate in a simulated bingo hall game.

16. The bingo game generator of claim 14, wherein the bingo game video further includes one or more pre-recorded video segments of an announcement of the bingo game result by a real person.

17. The bingo game generator of claim 14, further comprising a ticket validation module, wherein the ticket validation module compares the sequence of drawn bingo numbers to bingo game numbers on a specified ticket to determine matched numbers on the ticket.

18. The bingo game generator of claim 17, wherein the ticket validation module compares the sequence of drawn bingo numbers to the bingo game numbers on a plurality of tickets to determine winning tickets and a winning sequence of bingo calls.

19. The bingo game generator of claim 18, wherein the animation drawing subsystem retrieves matched video segments corresponding to the winning sequence of bingo calls and compiles the matched video segments into the bingo game video.
